(19) United States
(12) Patent Application Publication
(10) Pub. No.: US 2004/0049424 A1
(43) Pub. Date: Mar. 11, 2004

(54) System and method for facilitating ridesharing

(76) Inventors: Thomas A. Murray, McLean, VA (US); Frederick James Steele JR., Great Falls, VA (US)

Correspondence Address: Michael D. Bednarek, Shaw Pittman LLP, 1650 Tysons Boulevard, McLean, VA, 22102, US

(21) Appl. No.: 10/464,737

(22) Filed: Jun. 19, 2003

Related U.S. Application Data
(60) Provisional application No. 60/390,160, filed on Jun. 21, 2002.
(60) Provisional application No. 60/474,599, filed on Jun. 2, 2003.

(51) Int. Cl. G06F 17/60

(52) U.S. Cl. 705/14

(57) ABSTRACT

A system and method for facilitating and encouraging ridesharing, the method including tracking a quantity of rideshare participation by a rideshare participant, awarding an incentive to the rideshare participant based on the quantity, and receiving payments based on the rideshare participant's quantity of rideshare participation. A preferred embodiment awards incentives to commuters based on rideshare miles traveled or rideshare trips taken and pays for the incentives using credits earned by the commuters. The present invention reduces the number of single occupancy vehicles, reduces traffic congestion, and thereby reduces the pollution and greenhouse gases attributable to vehicle traffic. In this manner, the invention encourages more efficient use and conservation of energy resources, including the reduction of energy consumption relating to automobiles.

This application claims the benefit of U.S. Provisional Application No. 60/390,160, filed Jun. 21, 2002, and U.S. Provisional Application No. 60/474,599, filed Jun. 2, 2003, which are both herein incorporated by reference in their entirety.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Invention

The present invention relates generally to ridesharing, and more particularly, to a system and method for facilitating and encouraging automobile commuters to rideshare.

2. Background of the Invention

Traffic congestion in the United States is increasing at astounding rates, causing traffic jams, increased levels of pollution, and even road rage. Further complicating this problem are the highly constrained state and federal dollars available for building new roads and public transportation systems.

As a measure of the severity of the problem, the U.S. Department of Transportation estimates that Americans lose more than 16 million hours a day stuck in traffic. Equally alarming, the U.S. Department of Energy estimates that transportation accounted for 26% of greenhouse emissions in 1997, and is growing at 2.1% annually.

A significant source of the traffic problem is the average commuter's preference for single occupancy commuting. Studies estimate that almost 80% of commuters rely on single occupancy vehicles (SOVs) as their means of transportation to work, as opposed to ridesharing, using public transit, walking/biking, and working from home. Thus, any reduction in single occupancy vehicles results in immediate congestion relief. One feasible approach to reducing the number of single occupancy vehicles is to encourage single occupancy vehicle commuters to rideshare. As used herein, ridesharing refers to two or more people riding together in one vehicle in lieu of traveling alone.

Individuals who do rideshare today have relatively fixed schedules and rideshare primarily to save time, money, or both. They typically save time by traveling in designated high occupancy vehicle (HOV) lanes or by working during the trip (as a passenger, for example). They save money by splitting the costs of fuel, parking, and wear and tear on an automobile.

Despite these traditional benefits of ridesharing, most commuters continue to travel alone. The typical objections against ridesharing include the lack of HOV lanes along a travel route, the inconvenience of coordinating schedules with others, and the lack of flexibility to deal with emergencies or unexpected events. Moreover, a fair portion of commuters values the privacy and independence of traveling alone over any of the time and money advantages associated with ridesharing.

Thus, in the end, the perception of most commuters is that the traditional marginal benefits provided by ridesharing do not outweigh the convenience of traveling alone. Regrettably, this mentality only further fuels the problems of traffic congestion. Thus, in the interest of reducing traffic congestion, harmful pollutants (e.g., NOx, VOC, and CO), and greenhouse gas emissions (e.g., CO₂), automobile commuters need an incentive to rideshare that makes it worthwhile to give up the conveniences of SOV commuting.

### SUMMARY OF THE INVENTION

The present invention is a system and method for facilitating and encouraging ridesharing among commuters. Through incentives to commuters, the present invention reduces the number of single occupancy vehicles, reduces traffic congestion, and thereby reduces the pollution and greenhouse gases attributable to vehicle traffic. In this manner, the invention encourages more efficient use and conservation of energy resources, including the reduction of energy consumption relating to automobiles. Indeed, with 8 billion gallons annually, or roughly 50% of oil consumption in the US, coming from private automobiles, the reduced energy consumption realized by increased ridesharing could be in the hundreds of millions of gallons of oil annually.

The present invention identifies potential ridesharers for riders and drivers and helps them create ridesharing/carpool trips to get to work faster and save money. The invention serves both urban and rural travelers by removing cars from the roads, while at the same time providing the personal travel freedoms that automobile commuters have come to expect. Specifically, the present invention identifies compatible drivers and riders, and encourages these drivers and riders to participate in the rideshare program through a variety of incentives.

The incentives of the present invention compensate commuters for participating in a rideshare program. If, for example, a participant uses the system of the present invention to schedule a trip to work and back again with another person, both of the participants earn “rideshare miles” for their ridesharing trip. The rideshare miles are redeemable for cash or other benefits provided by vendor partners, such as store credit to spend at retail stores and frequent flyer miles to apply to airline tickets.

Optionally, instead of rideshare miles, participation can be quantified in many different ways, such as by the number of rideshare trips taken, the actual amount of reduced emissions (e.g., driving a fuel-efficient car instead of an inefficient one), the number of passengers taken, the time of day traveled, and the type of roadway taken (e.g., greater participation recognized if trip does not involve typically congested roads, such as major arteries).

The service provider that operates the present invention derives revenue in several ways. First, the service provider sells advertisements, sponsorships, and surveys that are placed on the interface (e.g., web site) through which the participants register and participate in the ridesharing program. The service provider operates this interface. In a further aspect, the advertisements, sponsorships, and surveys are highly targeted to the interests of a typical automobile commuter or rideshare participant. In a further aspect of the present invention, a sponsor or advertiser pays a fee to the service provider only after receiving a direct benefit of the advertisement or sponsorship, e.g., only after the sponsor or advertiser completes a sale with a rideshare participant.

As a second source of revenue, the service provider receives payments based on the quantity of participation by the rideshare participants. In one embodiment, this quantity of participation is measured in terms of credits. For example, the service provider collects the credits (e.g., emissions credits and vehicle miles traveled (VMT) credits) realized through the ridesharing and sells them. In this embodiment, upon registration, each participant agrees to assign to the service provider the participant's right to credits earned by ridesharing. The credits are released to the service provider, which can then sell the credits to interested third parties, such as power plant operators seeking to meet legislative pollution emission standards or global greenhouse gas emissions targets. As another example, the service provider could redeem VMT credits with governmental agencies that provide compensation for such credits. Alternatively, instead of vehicle miles traveled, the compensation could be based on rideshare trips taken.

As used herein, a credit refers to any unit of value that is derived from ridesharing. As an example, a credit may be based on reduced greenhouse gas emissions or reduced pollutants. Credits can be unregulated or regulated. For example, a buyer, such as a local government, may wish to buy credits based on reduced greenhouse gas emissions in an effort to reduce local greenhouse emissions, even though such credits are currently unregulated. In this case, the buyer assigns the value derived from ridesharing. On the other hand, regulatory credits assume that the government regulates the item (e.g., NOx and VOC emissions) and, because it is regulated, the regulatory credit has value. In this case, the marketplace of regulatory credit buyers and sellers determines the value of the credit.

As a third source of revenue, the service provider receives transaction fees for completing rideshare mile redemption transactions between vendor partners and rideshare participants.

As a fourth source of revenue, the service provider can receive membership fees from rideshare participants. In one embodiment, these rideshare participants pay membership fees in lieu of viewing advertisements and completing surveys.

Thus, the advertising revenue, the payments based on the quantity of participation, the transaction fees, and the membership fees can provide enough revenue for the service provider to cover the incentives given to rideshare participants, plus some measure of profit for the service provider.

The present invention can provide a variety of incentives for commuters to participate in a rideshare program. In one aspect of the invention, participants receive a monetary reward for each mile of ridesharing or each rideshare trip. For example, a participant could receive one cent per mile traveled as part of the rideshare program. In another example, a participant could be awarded a fixed number of “rideshare miles” for a ridesharing trip regardless of the actual miles traveled, and these “rideshare miles” could have a value of one cent each.

In another aspect of the invention, instead of, or in addition to, monetary rewards, participants can receive store credits to be used at a vendor that is in partnership with the service provider of the ridesharing program. Thus, for example, a rideshare participant might receive two cents to spend at a retail store for every mile traveled as part of the rideshare program.

In another aspect of the invention, the incentive to participate in the rideshare program is the entry of the participant into a lottery for a prize. For example, a participant could be eligible for a prize drawing after the participant accumulates a designated number of rideshare miles. This incentive would encourage the participant to accumulate miles without redeeming them for other incentives, such as monetary or store credit rewards, and would therefore give the service provider of the rideshare program some control over the incentive redemption behavior of participants. For example, the service provider could use mile-accumulating incentives to reduce the possibility that large numbers of participants would redeem miles at the same time and drain the monetary resources of the service provider and/or the vendor partners.

Similarly, in another aspect of the present invention, the incentive to participant in the rideshare program is gift rewards provided at designated quantities of accumulated miles. These gifts could be products, services, or benefits available as part of a customer status (e.g., premiere status). The customer status benefits could be similar to the special rights and services given to members of airline frequent flier programs.

According to another aspect of the invention, another incentive to participate in the rideshare program is the use of high occupancy vehicle (HOV) lanes. These lanes typically can only be used by vehicles carrying two or more occupants. Because of the overwhelming majority of single occupancy vehicles on the road, the HOV lanes tend to be less congested and faster moving than the remaining non-HOV lanes. Thus, participants in the rideshare program of the present invention can commute more quickly, saving time in addition to the money gained by rewards.

According to another aspect, sharing rides also reduces the travel expenses for each participant. Instead of individually shouldering the costs of gasoline and wear and tear on the automobile, the participants share the costs and thereby reduce each participant's individual contribution.

### BRIEF DESCRIPTION OF THE DRAWINGS

FIG. 1 is a schematic diagram illustrating an exemplary system for facilitating ridesharing, according to an embodiment of the present invention.

FIG. 2 is a schematic diagram illustrating exemplary transactions that occur as part of a rideshare program, according to an embodiment of the present invention.

FIG. 3 is a schematic diagram illustrating an exemplary process for building a travel buddy list, according an embodiment of the present invention.

FIG. 4 is a schematic diagram illustrating an exemplary process for scheduling a rideshare trip, according to an embodiment of the present invention.

FIG. 5 is a screen image of a main screen of an exemplary user interface for facilitating a rideshare program, according to an embodiment of the present invention.

FIG. 6 is a screen image of a rideshare mile redemption screen of an exemplary user interface for facilitating a rideshare program, according to an embodiment of the present invention.

FIG. 7 is a table summarizing exemplary credit (DART) pricing, according to an embodiment of the present invention.

FIG. 8 is a table summarizing exemplary peak-hour congestion relief pricing, according to an embodiment of the present invention.

FIG. 9 is a screen image of a main screen of another exemplary user interface for facilitating a rideshare program, according to an embodiment of the present invention.

FIG. 10 is a screen image of an exemplary user interface for establishing a regular commute of a rideshare participant, according to an embodiment of the present invention.

FIGS. 11 and 12 are screen images of an exemplary user interface for establishing a rideshare participant's profile, according to an embodiment of the present invention.

FIGS. 13 and 14 are screen images of an exemplary user interface for searching for compatible rideshare trips, according to an embodiment of the present invention.

FIG. 15 is a screen image of an exemplary user interface for displaying trip details, according to an embodiment of the present invention.

FIG. 16 is a screen image of an exemplary user interface for displaying detailed information about trip origination and destination locations, according to an embodiment of the present invention.

FIG. 17 is a screen image of an exemplary user interface for displaying detailed information about potential ridesharing partners, according to an embodiment of the present invention.

FIG. 18 is a screen image of an exemplary user interface for establishing trip reminders, according to an embodiment of the present invention.

FIG. 19 is a screen image of an exemplary user interface for searching for and managing a list of travel buddies, according to an embodiment of the present invention.

FIG. 20 is a screen image of an exemplary user interface for reporting rideshare trip activity, according to an embodiment of the present invention.

### DETAILED DESCRIPTION OF THE INVENTION

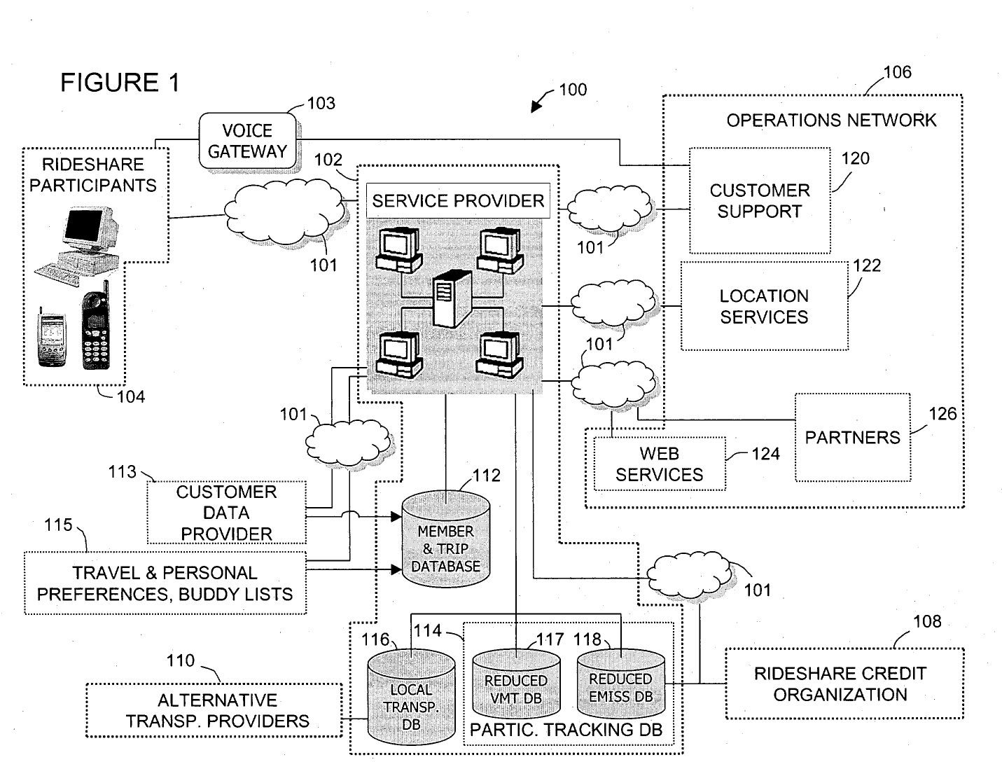

FIG. 1 illustrates an exemplary system 100 for facilitating ridesharing, according to an embodiment of the present invention. As shown, system 100 includes a service provider 102, rideshare participants 104, and an operations network 106. Optionally, system 100 can also include rideshare credit organization 108 and alternative transportation providers 110. Service provider 102 is preferably in communication with rideshare participants 104, operations network 106, rideshare credit organization 108, and alternative transportation providers 110 through a computer network 101, such as the Internet. Service provider 102 is preferably also in communication with rideshare participants 104 through a voice gateway 103, such as a public switched telephone network or a wireless telephone network.

Service provider 102 administers the rideshare program of the present invention. As part of this administration, service provider 102 communicates rideshare incentives to rideshare participants 104, facilitates the matching of rideshare participants 104 for rideshare trips, stores personal information of rideshare participants 104, tracks the rideshare participation (e.g., miles traveled) by rideshare participants 104, facilitates the awarding of incentives to rideshare participants 104 based on the participation (e.g., accumulated rideshare miles), collects and sells the credits earned by rideshare participants 104, and facilitates alternative transportation for rideshare participants 104 that cannot set up a rideshare trip.

To serve these functions, service provider 102 has access to a member/trip database 112, a participation tracking database 114, and a local transportation database 116. Although FIG. 1 shows these databases as part of service provider 102, the databases could, of course, be physically distinct from service provider 102, for example, maintained by a third party provider. In additions although the databases are shown as individual databases, the databases could, of course, be a single database or any combination of individual distributed databases.

Member/trip database 112 contains member and trip information for each rideshare participant 104 and rideshare trip, which can be used to identify viable member and trip matches. Examples of member information include address, criminal record, driving record, insurance information, credit card data, vehicle identification number (VIN), and other background-check information. Examples of trip information include typical trip originations and destinations for a participant, such a participant's daily commute to work or frequent trips to a grocery store.

In one embodiment, as shown in FIG. 1, a customer data provider 113 furnishes the member information data. Examples of customer data providers 113 include state motor vehicle administrations and credit reporting agencies such as Equifax™. Member/trip database 112 can also include travel preferences, personal preferences, and buddy lists for each rideshare participant 104. As shown in the embodiment of FIG. 1, rideshare participants 104 can provide such information via registration data 115 (e.g., answers to questionnaires or imported data files).

Participation tracking database 114 contains data on the quantity of participation by rideshare participants 104. For example, participation tracking database 114 can contain the rideshare miles traveled by rideshare participants 104 and the number of credits earned by those miles. Alternatively, the credits could be based on rideshare trips, instead of miles. In this example, participation tracking database 114 includes two types of credits, stored in a reduced VMT database 117 and a reduced emissions database 118. An example of a credit is a Mobile Source Emission Reduction Credit (MERC), as defined by the Environmental Protection Agency of the United States. MERCs are based on NOx and VOC, and help states meet their mandated clean air requirements under the Clean Air Act of 1990.

Rideshare participants 104 participate in the rideshare program administered by service provider 102. According to an embodiment of the present invention, participation occurs at varying levels, for example, as an introductory user of the user interface of service provider 102, as an observer of the rideshare features of the user interface, or as an active rider. The introductory user is limited to accessing basic information about the rideshare program, for example, by viewing the home page and frequently-asked-questions page of web user interface provided by service provider 102.

An observer and an active rider are members of the rideshare program and have full access to the user interface of service provider 102. However, the observer can only view activities occurring over the user interface, while the active rider can participate in those activities (e.g., arranging a rideshare trip). The observer and active rider levels of participation are discussed in more detail below.

Operations network 106 supports features provided as part of the rideshare program of service provider 102. As shown in this example, operations network 106 includes customer support 120, location services 122, web services 124, and partners 126. Customer support 120 interacts with rideshare participants 104, either through the user interface of service provider 102 or directly with participants 104, for example, through voice gateway 103. Customer support 120 preferably has access to member/trip database 112 and local transportation database 116 so that customer support 120 has the information necessary to respond to the inquiries of rideshare participants 104.

Location services 122 provide service provider 102 with location data and location-based services associated with rideshare participants 104. For example, location services 122 could include a mapping application that displays a map corresponding to a travel route entered by a rideshare participant 104. As another example, location services 122 could provide a global positioning system that instantaneously tracks the location of rideshare participants 104 during a trip.

Location-based services could be coupled with the global positioning system, for example, sending relevant local retailer information to a mobile wireless device of a rideshare participant 104 during the trip. Location-based information may also be used to validate participant activity in ridesharing trips. For example, service provider 102 may track the location of participants using location based services that monitor the mobile telephone location. Based on the location of the mobile telephones, the service provider 102 can determine if the participants traveled together along the stated ridesharing route.

Web services 124 provide enhanced features for the user interface of service provider 102. For example, web services 124 could include chat communication, instant messaging, and community bulletin boards.

Partners 126 provide rideshare incentives for rideshare participants 104. For example, in exchange for a partner's advertisement placed on the user interface of service provider 102, the partner could provide goods or services to rideshare participants 104, based on a quantity of participation (e.g., the number of redeemed rideshare miles). In this case, partners 126 could include, for example, retailers, airlines, and resellers. In one embodiment of the present invention, partners 126 pay advertising fees only after receiving a direct benefit, such as a sale completed with a rideshare participant. As another incentive, partners 126 could provide lottery services.

Although FIG. 1 shows operations network 106 as an entity separate from service provider 120, one or more components of operation network 106 could be a part of service provider 120. For example, service provider 102 could directly administer web services 124 and location services 122.

Rideshare credit organization 108 credits service provider 102 for rideshare miles traveled by rideshare participants 104. These credits have value on a corresponding credit market, in which payors purchase the credits. Rideshare credit organization 108 could be, for example, a federal government agency such as the U.S. Department of Energy (DOE), which logs reduced emission credits earned by companies. As another example, rideshare credit organization 108 could be a state or local government agency that credits service provider 102 with VMT credits based on the rideshare miles traveled by rideshare participants 104. Rideshare credit organization 108 could also be a private organization that credits rideshare miles.

In tracking the credits earned by service provider 102, rideshare credit organization 108 can maintain its own database, such as DOE's 1605(b) database, or can access the accumulated credits from participation tracking database 114, as represented in FIG. 1. Alternatively, service provider 102 can communicate the quantities of participation (e.g., rideshare miles and earned credits) to rideshare credit organization 108 through computer network 101.

In addition to tracking and crediting rideshare miles, rideshare credit organization 108 can also pay service provider 102 directly for the credits. For example, instead of simply assigning service provider 102 credits, which can then be sold in some corresponding market, the rideshare credit organization 108 can, as a payor, pay service provider 102 directly for the credits. An example of this situation would be a government agency acting as rideshare credit organization 108, whereby the government agency tracks the credits and pays service provider 102 for the credits using taxpayer funds, in an effort to promote traffic congestion relief.

Alternative transportation providers 110 provide service provider 102 with information and services relating to alternatives to ridesharing. Service provider 102 stores this information in local transportation database 116 for access by rideshare participants 104. The information could include, for example, bus, subway, and train schedules. In addition, alternative transportation providers 110 could include dispatchers that send transportation (e.g., taxis and commuter vans) to rideshare participants 104.

In an aspect of the present invention, service provider 102 guarantees rideshare participants 104 a return trip (e.g., a return trip from work). Service provider 102 can use alternative transportation providers i 10 to provide this guaranteed return trip.

In another aspect of the present invention, service provider 102 provides rideshare participants 104 with the use of a shared vehicle. In this manner, rideshare participants can rideshare to a location and then use the shared vehicle to make trips back and forth to that location (e.g., run errands from work).

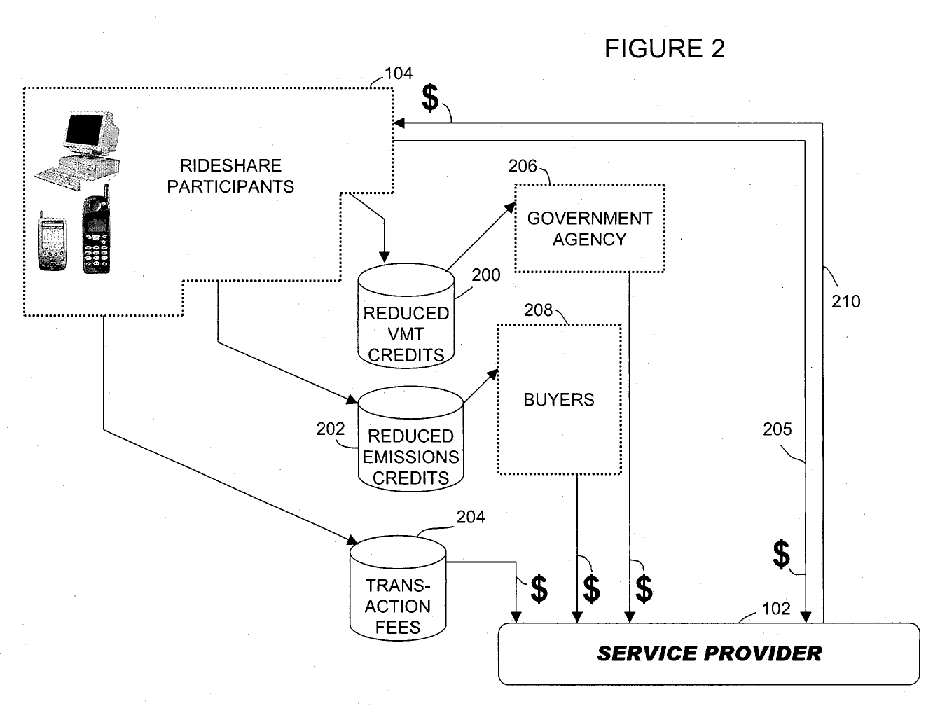

With the system architecture of FIG. 1 in mind, FIG. 2 illustrates the transactions that occur as part of an exemplary rideshare program administered by service provider 102. Specifically, FIG. 2 illustrates the cash inflow and outflow from the perspective of service provider 102. As shown in the example, as the rideshare participants 104 schedule, confirm, complete, and log rideshare trips, and redeem their rideshare miles, they provide several revenue streams for service provider 102. These revenue streams can relate to reduced VMT credits 200, reduced emissions credits 202, transaction fees 204, and membership fees 205.

Service provider 102 turns the reduced VMT credits 200 into an appropriate government agency 206. In return, government agency 206 compensates service provider 102.

With the reduced emissions credits 202, service provider 102 looks to an emission credit market on which to sell the credits. Buyers 208 of the emission credit market, such as corporations and power plants, purchase the emission credits so that they can either meet regulations limiting the total emissions attributable to an entity or simply as a way to offset their unregulated emissions. Service provider 102 therefore receives payment from buyers 208.

Transaction fees 204 include advertising, sponsorships, surveys, and rideshare mile redemption fees. Service provider 102 collects these fees 204 from partners 126 for advertising, sponsorship, etc. based on, for example, the total number of redemptions, the total number of rideshare miles redeemed, or the number of click-throughs of a partner's advertisement displayed on the user interface of service provide 102. Fees might also be obtained from other third party companies for advertising sponsorships and the like.

On the cash outflow side, either service provider 102 can provide rideshare participants 104 directly with compensation 210, such as cash, goods and services, or these benefits can be provided directly from a vendor partner 126. According to one embodiment, service provider 102 sets limits on the value of compensation 210 awarded to rideshare participants 104 relative to the revenue that service provider 102 receives from the revenue streams. In this manner, service provider 102 can maintain a profitable operation.

Thus, the present invention provides an innovative transportation service that pays individuals for their rideshare participation, for example, based on each mile that they rideshare or each ridesharing trip they take. The individuals earn rideshare miles that are redeemable for cash and other valuable products and services, such as a lottery. The descriptions under the following headings describe an exemplary features and implementations of the system and processes of FIGS. 1 and 2, including further and alternative embodiments of the present invention.

### Membership

In an embodiment of the present invention, to use the rideshare service, an individual must first sign up to become a member. In an exemplary implementation, a member of the service can be either an observer or an active rider. To become an observer, an individual must enter minimal information such as name, address, and email address. In addition, an observer must also create a unique name, which the observer then uses for identification in interacting with the service provider and other members of the rideshare service. The observer status allows an individual to view the network of rideshare members and observe how that network is forming, how it works, and how it might benefit the individual. Observers cannot schedule or take trips through the rideshare service until they convert their observer status into an active rider.

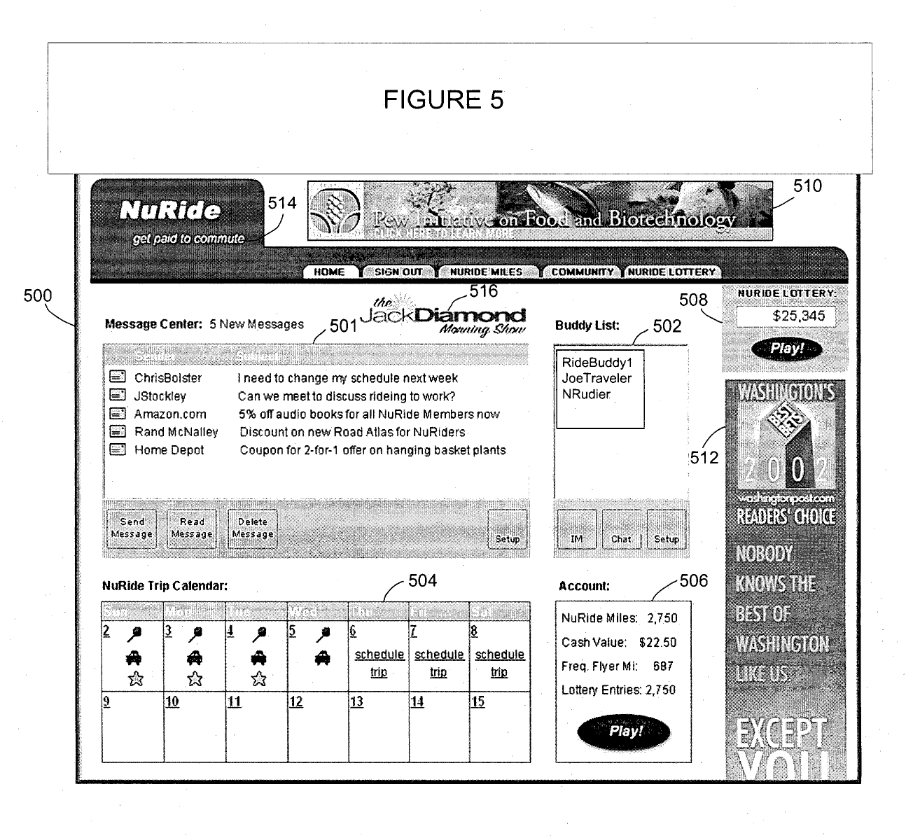

In contrast, an active rider can, after logging in, use all features provided by the user interface of service provider 102. FIG. 5 illustrates an exemplary main screen 500 through which an active rider interacts with service provider 102. As shown, this exemplary main screen 500 includes a message center 501, a buddy list 502, a trip calendar 504, an account status 506, and a lottery link 508, along with a banner advertisement 510, skyscraper advertisement 512, promotional messages 514, and sponsorship logos 516. These features available through main screen 500 are discussed in more detail below.

In an embodiment of the present invention, to become an active rider, individuals may be required to pass a qualification process. As an example, this qualification could involve verifying an individual's home address, validating the individual's credit card, and conducting a full background check on the individual, including criminal, driving, vehicle, and insurance record checks.

Beyond background checks, in a further embodiment of the present invention, riders also provide personal information, such as employment, travel preferences, and personal preferences. This personal information, which is stored in member/trip database 112 of FIG. 1, is used to help members find compatible travel partners for ridesharing. Travel preferences could include such items as the workdays, work/commuting hours, car type, and commuting patterns. Personal preferences could cover individual concerns such as smoking preference, likes, interests, dislikes, and tastes. An example of travel and personal preferences could be:

Live in Reston, Va.

Work in Washington, D.C.

Work days: Monday through Friday

Work hours: 8:00 am-5:00 pm

Travel flexibility: within 30 minutes

Non-smoker

Likes football and baseball

Listens to talk radio

### Finding Travel Partners

When an individual becomes a rider, the user interface of the present invention presents the rider with a list of other riders whom the rider may want to consider for future ridesharing. Each one of these potential ridesharing candidates is presented to the rider, along with information that allows the rider to contact the other rider and to initiate a dialogue that will help the parties determine if they would like to rideshare together in the future.

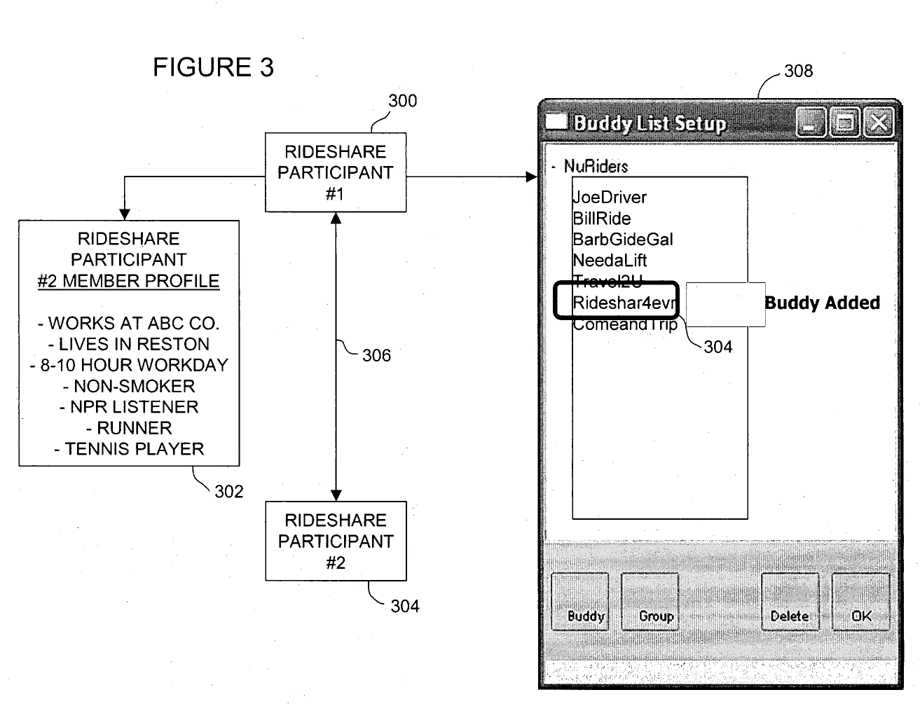

Thus, the present invention presents a list of travelers who meet a rider's travel criteria. The riders then decide among themselves if they wish to travel together. This exemplary process of finding compatible riders and building a buddy list is illustrated in FIG. 3.

As shown, a first rideshare participant 300 searches for a second rideshare participant 304 who matches a specified profile. If the first rideshare participant 300 finds the second rideshare participant 304 to be compatible, the first rideshare participant 300 initiates contact 306 with the second rideshare participant 304 either through the user interface of the present invention (e.g., through message boards) or through other communication means such as email or telephone. If, through this communication, an agreement to rideshare is reached, then the two riders add each other to their travel buddy lists. FIG. 3 shows rideshare participant 304 added to the travel buddy list 308 of rideshare participant 300. FIG. 5 shows another exemplary travel buddy list 502. The travel buddy list contains the names of all the riders with whom an individual has chosen to rideshare for future rides.

In an embodiment of the present invention, matching riders are added to each other's buddy list only after both parties agree to the match. In this manner, the present invention ensures that the parties are in agreement before facilitating a rideshare between them. Likewise, if one rider initiates the removal of the other rider from her travel buddy list, then the initiating rider is automatically removed from the other rider's travel buddy list, indicating that neither party can rideshare with the other.

### Scheduling Trips

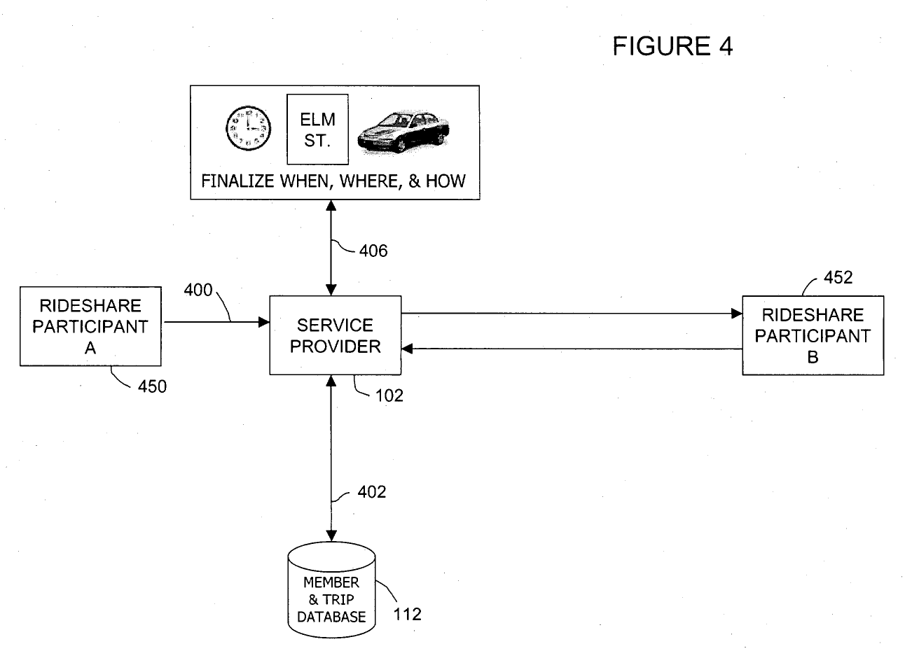

In an embodiment of the present invention, after a rider becomes an active member, the rider can schedule rideshare trips. FIG. 4 illustrates an exemplary process for scheduling a rideshare trip. Riders can make each trip a custom trip with unique date, time, and travel parameters. Alternatively, to facilitate the rapid scheduling of trips, riders can designate a list of regular trips that can be selected for fast scheduling. These predetermined trips are referred to herein as “one-click-trips.” For example, a rider may have a trip called “regular trip to work,” which contains the parameters of weekday, time of departure, and other items associated with this trip. This trip would be stored in the individual's list of “one-click-trips.”

To schedule trips, a rideshare participant 450 enters a trip request into the user interface of service provide 102, as represented by step 400 in FIG. 4. The user interface could be, for example, an Interactive Voice Response Unit (IVRU), a web site or other interface accessible via the Internet, or an application that users install on either their computers or wireless Internet access devices. After accessing the rideshare user interface, rideshare participant 450 can select the “schedule trip” option and then select a predetermined “one-click-trip” or a custom trip. Then, as shown in step 402, service provider 102 searches member/trip database 112 to see if there are any trips that match the search request. Service provider 102 can also limit the search to include only those trips posted by individuals who are included on the travel buddy list for rideshare participant 450.

Once potential rideshare trips are found, they are ranked according to how well they match rideshare participant 450's search request and presented to rideshare participant 450 for review. For each trip presented, rideshare participant 450 can review the exact trip details and the information on each participating individual, including their travel preferences and contact information. When rideshare participant 450 finds a desired trip, she accepts the trip via the user interface provided by service provider 102, whereupon service provider 102 then promptly informs all parties of the trip information. The user interface presented by service provider 102 facilitates the collection and management of the rideshare trip information and also presents the contact information necessary to facilitate direct communication between rideshare participants using, for example, email or instant messaging. When a trip is completely scheduled, service provider 102 may return a special trip identification and password to the ridesharing participants.

At a preset time before the trip is taken, service provider 102 contacts all ridesharing parties (e.g., via voice or email) to remind them of the trip and asks them to confirm their participation in the trip. This final step helps the parties ensure that the trip is scheduled properly and that the parties will participate as originally planned. When the parties meet and begin their trip, they verify that they each have the same password and identification and the trip begins.

In an embodiment of the present invention, the service provider may present advertisements to the rideshare participants during all aspects of their interaction with the user interface of the service provider, for example, during trip scheduling and trip logging.

### Logging Trips

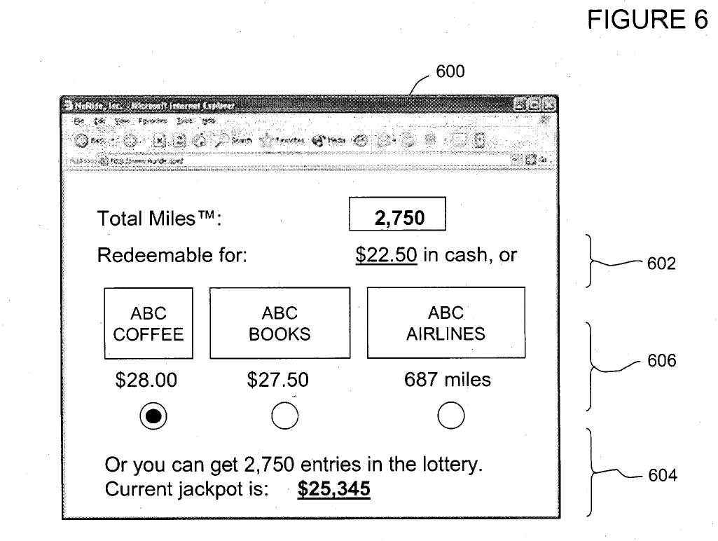

After a trip has concluded, the service provider contacts the rideshare participants and asks them to confirm that the trip was actually taken. If all the rideshare participants confirm the trip, then each participant receives an allotment of rideshare miles in her rideshare account. In an exemplary implementation of the present invention, the rideshare participant who drove may receive a quantity of rideshare miles that is different (e.g., greater) than the quantity received by the passengers, and may vary based on the time of day, road driven, miles traveled, passengers carried or vehicle driven. The rideshare miles are accumulated and stored in a rideshare participant's personal account for future redemption. An exemplary account is shown as account 506 in FIG. 5 and also in FIG. 6.

In a further embodiment of the present invention, in addition to confirming a trip, the rideshare participants can also provide feedback on each other through a ride feedback system at the conclusion of each trip. Rideshare participants who travel together can grade each other on the travel experience and can also provide commentary on each other in an open comment line. Rider participants who receive poor feedback can, for example, be prohibited from participating in future rideshares. Each rideshare participant's feedback score is available for all other rideshare participants to see at any time. This highly visible feedback mechanism is especially helpful for new rideshare participants who are considering someone for their buddy list, as it provides valuable insights into the experiences of other rideshare participants who have traveled with the individual before.

### Redeeming Rideshare Miles

In a specific implementation of the present invention, rideshare participants can redeem their rideshare miles with the service provider in exchange for cash, goods, services, or other benefits. Preferably, the rideshare miles are accumulated in real-time and can be redeemed online. FIG. 6 illustrates a rideshare mile redemption screen 600 of an exemplary user interface. As an example, rideshare miles can be redeemed in any of the following ways:

Cash 602 in the form of a direct payment to the individual, less any cash processing fees;

Entries into a lottery 604; or

Merchant benefits 606 such as:

A gift certificate with a merchant, or a credit on a merchant's debit card; or

Frequent flyer miles transferred to an individual's frequent flyer program;

Cash payment towards merchandise offered on the service provider's web site; and

Payment towards the service provider's premier services.

According to an embodiment of the present invention, a lottery involves periodic drawings for cash and/or prizes. A fixed number of rideshare miles, as determined by the service provider from time to time, can be redeemed for one entry into the lottery. The value of the lottery jackpot may increase for every rideshare mile contributed, thereby making the lottery jackpot significant in value when it is combined with a base contribution by the service provider and/or any number of participating merchants.

According to another embodiment of the present invention, when members redeem rideshare miles, the service provider may charge a processing fee for enabling the transaction. Some fees are direct to the member, such as cash processing fees, while other fees are not borne by the member but by the beneficiary of the transaction, such as the retailer who allows rideshare participants to purchase products or services using rideshare miles and provides an incentive back to the service provider.

### Local Transportation Network

In an embodiment of the present invention, the service provider also provides rideshare participants with information on local transportation alternatives, including taxi, rail, bus, rental car, and other transit options. With reference to FIG. 1, service provider 102 accesses this information from local transportation database 116, which contains information provided by alternative transportation providers 110. With this feature, if a rideshare participant cannot secure a desired rideshare trip, then the participant can access the other alternative travel information and plan the trip accordingly.

This alternative transportation option can also include the option for travelers to have paid accounts with the service provider, whereby the service provider can dispatch paid transportation services (e.g., taxis) on behalf of the traveler and the rideshare participant can be billed directly by the service provider. These paid services can also be reconciled by redeeming rideshare miles toward the price of the services.

In a further aspect of the present invention, the service provider guarantees that a rideshare participant will have a return trip after taking a rideshare trip to some location (e.g., to work). Thus, for example, if a participant's return rideshare arrangements fall through, the service provider provides alternative transportation for the return trip. The service provider can use the local transportation services to fulfill this need.

### Rideshare Community and Messaging Center

In another embodiment of the present invention, the service provider supports a message center through which rideshare participants can communicate with each other and through which the service provider can send special offers and advertisements to the rideshare participants. FIG. 5 shows an exemplary message center 501. The message center is adapted to coordinate with the type of user interface the service provider provides. For example, messaging between rideshare participants can be accomplished with text messages, voice messaging, or instant messaging. The messages are sent to an individual rideshare participant's message center where they are processed accordingly. Instant messages can be initiated between rideshare participants when they are both logged into the web user interface of the service provider, facilitating real-time communications.

Preferably, the service provider maintains the personal contact information of rideshare participants in confidence. In this manner, rideshare participants must communicate through the message center unless they determine on their own to share their personal contact information with other rideshare participants.

In addition to the message center, a further embodiment of the present invention provides a community forum in which members can have chat sessions and threaded discussions concerning any and all topics of relevance to the community. In this manner, rideshare participants can share ideas on meeting new rideshare participants, on the most efficient travel routes, and on other important local travel information.

### Mobile Tracking

According to an embodiment of the present invention, for rideshare participants who communicate with the service provider using a mobile device (e.g., either Internet or voice related), the service provider is linked with global positioning systems (e.g., location services 122 of FIG. 1) to determine the location of the rideshare participants. This real-time location-based information enables the service provider to assist in linking rideshare participants and in making trip matches quickly and efficiently. The service provider can work with a variety of location-based technologies to support the mobile needs of the rideshare participants.

This location-based information can also be integrated into a tracking system, by which members can be monitored and tracked while they are ridesharing. With this tracking, the service provider can dispatch additional services as requested, such as a tow truck if a breakdown occurs. The service provider can also use the location-based information to confirm the rideshare miles reported by rideshare participants.

### Sale of Emissions Credits

According to an embodiment of the present invention, when an individual becomes a member of the service provider's service, the individual agrees to assign to the service provider her right to own or resell any of her reduced vehicle emissions realized through ridesharing supported by the service provider's service. The service provider therefore owns the exclusive right to hold, sell, or trade these credits. For example, if two people take a 20-mile trip, each in their own car, the total travel distance for the two people would be 40 miles, and the resulting auto emissions would be calculated based on two cars traveling 40 miles. However, if these two people schedule a rideshare trip through the service provider, and they travel 20 miles together in one car, then the service provider owns the reduced emissions from the 20 miles that the rideshare trip has taken off the road. The emissions are logged into measurable systems, such as the U.S. Department of Energy's 1605(b) database, and include, but are not limited to, CO₂ and NOx (oxides of nitrogen).

### Sale of Reduced Vehicle Miles Traveled

In another embodiment of the present invention, when an individual becomes a member of the service provider's service, the individual also agrees to assign to the service provider her right to own or resell her reduced vehicle miles traveled, or “VMT.” The service provider therefore owns the exclusive right to hold, sell, or trade the value of the reduced VMT. As in the example above, the rideshare trip created a net reduction of 20 vehicle miles traveled. This reduced VMT results in reduced road maintenance, reduced load on road services, reduced traffic congestion, a reduced number of accidents, and numerous other positive by-products. According to this embodiment, the service provider owns the right to sell the reduced VMT to public and private organizations.

### Paid Memberships

While the system described herein provides incentives for rideshare participants to gain cash and other rewards, an embodiment of the present invention also includes paid memberships, whereby rideshare participants may pay a monthly fee or services fees based on use of the ridesharing service or other services provided by service provider 102.

### Exemplary Implementation

As described above, in one embodiment of the present invention, a service provider collects credits realized through the ridesharing and sells them. According to one aspect of the present invention, a credit is defined as a greenhouse gas (GHG) credit, which is based on reduced carbon dioxide (CO₂) emissions and reduced roadway maintenance realized through the reduction in vehicle miles traveled.

In an exemplary implementation of this embodiment, a buyer in the Seattle, Wash. area (which is, for example, buyer 208 of FIG. 2) stated that they would purchase tons of greenhouse gases (MgCO2e) for a base price of $3/MgCO2e, and that they would be willing to pay a “premium” above this base price for programs that also provided additional benefit to the Seattle region, especially in the area of transportation congestion relief.

Washington State spends roughly $8,500 to maintain a single mile of roadway each year, as reported by the Washington State Department of Transportation (WSDOT). WSDOT also reports that there are roughly 7,000 miles of roadway throughout the state with an estimated 31 billion vehicle miles being traveled along those roadways each year. From these figures, the dollars expended annually per vehicle mile traveled (VMT) is then calculated to be $0.002/VMT. Converting this to a GHG equivalent price yields $5.33/MgCO2e as shown in the equations below.

$$\begin{matrix}\frac{( \$ spent on roadway maintenance )}{( miles of roadway maintained )} * \frac{( miles of roadway maintained )}{( vehicle miles traveled )} = \frac{\$ 8 , 500 * 7 , 000}{31 , 000 , 000 , 000} = \$ 0.002 / VMT \\ \frac{( \$ / VMT ) * lbs {CO}_{2} / mile ) }{2204 lbs / Mg CO2e} = \frac{\$0 .002 / VMT * 2204 lbs / Mg CO2e}{0.827 lbs {CO}_{2} / mile} = \$ 5.33 / Mg CO2e\end{matrix}$$

By combining the value of the reduced roadway maintenance of $5.33/MgCO2e with the base price of $3/MgCO2e for the carbon dioxide reductions, the buyer 208 (see FIG. 2) in Seattle, Wash. would pay service provider 102 (see FIG. 2) approximately $8/MgCO2e for each GHG credit. Normalizing reduced roadway maintenance costs to an MgCO2e is a straightforward way to assign monetary value to just one of the many benefits of ridesharing-related GHG offsets. Other benefits include, but are not limited to, cost savings associated with reduced land-use impacts, emergency services, and congestion delays.

### Additional Exemplary Implementation

According to another aspect of the present invention, a credit is defined as a Drive-Alone Reduction in Travel, or “DART.” A DART is defined as a unit of congestion relief realized when a drive-alone trip is substituted with ridesharing. The service provider delivers a DART to the rideshare credit organization, which could be, for example, a state such as Virginia. A DART is equivalent to the value of a unit of reduced VMT and includes three core elements: 1) emissions reductions (e.g., oxides of nitrogen, or NOx, and volatile organic compounds, or VOC); 2) reduced roadway maintenance; and 3) peak-hour congestion relief. Each of these elements is normalized by vehicle miles traveled (VMT) and totaled to provide a final DART value in dollars per VMT ($/VMT).

Thus, a DART is calculated as follows:

$$DART = VALUE OF REDUCED VMT = VALUE OF REDUCED EMISSIONS + VALUE OF REDUCED ROADWAY MAINTENANCE + VALUE OF PEAK \text{-} HOUR CONGESTION RELIEF$$

Reductions in emissions are realized when a commuter chooses to rideshare in lieu of driving alone. Using an active ridesharing database (e.g., participation tracking database 114 of FIG. 1), the present invention can directly compute NOx and VOC reductions attributable to each ridesharing trip. These reductions are then included in the DART.

With regard to the value of reduced roadway maintenance, roadways degrade over time based on a number of factors, all of which can be related to the total vehicle miles traveled over the roadway. Simply put, the more a road is driven on, the faster it wears out. As such, there is a measurable reduction in roadway maintenance for each VMT removed from the roads. This reduction in roadway maintenance is included in the DART.

With regard to the value of peak-hour congestion relief, fundamentally, congestion results when vehicular demand exceeds a roadway's capacity. To alleviate existing congestion, governments engage in various roadway construction projects. Normalizing the cost of each project over the lifecycle VMT of the new roadway yields a cost per VMT that is being expended to relieve existing congestion today. By removing cars from congested roadways during peak hours, the present invention provides the same relief value. As such, the equivalent peak-hour congestion relief value is included in the DART.

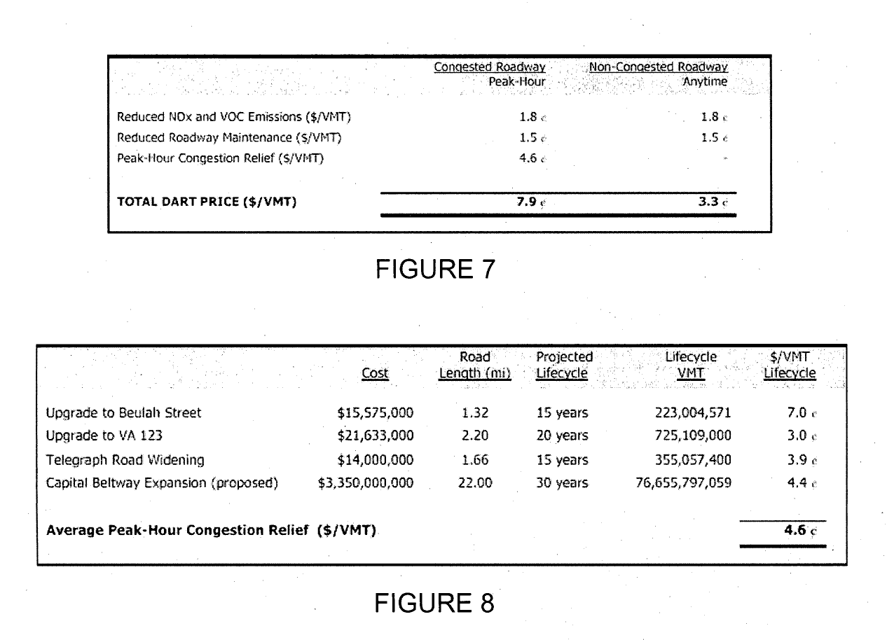

In an exemplary implementation of this embodiment based on the Northern Virginia area, the value of a DART is priced at 7.9¢/VMT for peak-hour reductions on congested roadways and 3.3¢/VMT for all other roads at all other times. FIG. 7 shows a table summarizing this exemplary DART pricing, breaking down the total DART price into the components of reduced NOx and VOC emissions, reduced roadway maintenance, and peak-hour congestion relief. Exemplary methods for calculating each of these components are described under the following corresponding subheadings.

### Reduced NOx and VOC Emissions Value

Reductions in mobile source NOx and VOC are realized when a commuter chooses to rideshare in lieu of driving alone. To determine the value of these NOx and VOC emissions on a per VMT basis, the running emissions factors (expressed in grams per VMT) are multiplied by a price per ton for both NOx and VOC, and then summed. As an example, this calculation could rely on the 2005 running emissions factors as set forth in the Transportation Planning Board's (TPB) report, “Air Quality Conformity Determination of the 2002 CLRP and the FY 2003-2008 TIP for the Washington Metropolitan Region,” dated Jul. 17, 2002. The running emissions factors used are as follows:

NOx running emissions factor=1.2388 grams/reduced VMT

VOC running emissions factor=0.4316 grams/reduced VMT

According to the above referenced TPB, to address the 2005 8-ton NOx overage, the plan called for implementing programs that ranged from $1,395/ton/yr up to $4,800,000/ton/yr. Normalizing these figures into a simple price per ton, and then averaging them indicates that the region paid approximately $60,000/ton for NOx. While Northern Virginia's contribution was lower due to its one-time elimination of certain road projects, it is unlikely that this method of achieving NOx reductions is sustainable or desirable.

As this example is based on private-sector NOx and VOC reduction, it is more appropriate to use market based prices as a comparable figure. Market prices for NOx and VOC vary dramatically based on the region of the U.S. and the season, with some prices in the San Diego area recently reaching $130,000/ton NOx and $65,000/ton VOC. According to Cantor Fitzgerald's EmissionsTrading.com, Maryland emission reduction credits (ERC) for NOx and VOC trades from October 2002 were priced at $11,350 and $5,750 respectively (see www.emissionstrading.com/index_mpi.htm). While these trades are for stationary sources and not mobiles sources, these prices are comparable since they are market driven and closely represent the Northern Virginia region.

Using these market prices and the aforementioned running emissions factors, the reduced NOx and VOC emissions value can be calculated on a dollar per VMT basis ($/VMT). The result is a total NOx and VOC emissions value of 1.8¢/VMT as shown below:

NOx ($/VMT)=1.2388 gram/VMT×$11,350/ton÷907,195 grams/ton

NOx ($/VMT)=1.5¢/VMT

VOC ($/VMT)=0.4316 gram/VMT×$5,750/ton÷907,195 grams/ton

VOC ($/VMT)=0.3¢/VMT

Reduced NOx and VOC Emissions ($/VMT)=1.5¢/VMT+0.3¢/VMT

Reduced NOx and VOC Emissions ($/VMT)=1.8¢/VMT

### Reduced Roadway Maintenance

For every reduced VMT, there is a corresponding reduction in roadway wear and tear. To calculate the value of the roadway maintenance savings, the total roadway maintenance expenditures are divided by the total VMT throughout the Commonwealth of Virginia. Since 2002 figures for VMT are not published at this time, 2001 figures for both VMT and roadway maintenance expenditures were used to ensure a consistent, conservative analysis. According to the VDOT Budget FY '01-'02 (see www.virginiadot.org/infoservice/resources/budget-02-Final-Revised.pdf), total expenditures on roadway maintenance were approximately $1.1 B. Correspondingly, the Federal Highway Administration stated that total Virginia VMT for 2000/2001 was approximately 74 billion VMT (see www.fhwa.dot.gov/ohim/hbs/va.htm). Dividing the total expenditures by the total VMT yields a roadway maintenance value of 1.5¢/VMT as shown below:

Virginia Roadway Maintenance Expenditures ('01-'02)=$1,100,000,000

Virginia VMT ('01)=74,000,000,000

Reduced Roadway Maint. ($/VMT)=$1,100,000,000÷74,000,000,000 VMT

Reduced Roadway Maintenance ($/VMT)=1.5¢/VMT

It should be noted that numerous studies have shown that roadway maintenance in congested urban areas is more costly than rural roadway repairs. However, in order to provide a conservative analysis, statewide figures are used in lieu of Northern Virginia regional figures.

### Peak-Hour Congestion Relief

Congestion results when vehicular demand exceeds a roadway's capacity. Roadways are subsequently built and expanded to alleviate peak-hour congestion. By removing cars from peak-hour congested roadways, the present invention provides the same benefit. To calculate the value of this benefit, an analysis was conducted to determine the value, expressed in terms of dollars per lifecycle VMT, for an average roadway development project in Northern Virginia. For this analysis, lifecycle VMT is defined as the total VMT over a segment of roadway before it is re-congested to a level that exceeds current congestion delays and, therefore, requires further modification or expansion. The analysis focused on four Northern Virginia roadway projects, three that are currently in development and one that represents a theoretical expansion of the Capital Beltway. The summary findings for these four projects are set forth in the table of FIG. 8.

As shown in FIG. 8, congestion relief costs, expressed in terms of dollars per VMT ($/VMT), range from 3¢/VMT to 7¢/VMT, with the average value being 4.6¢/VMT. This value of 4.6¢/VMT is then included in the DART calculation for trips that contain travel on peak-hour congested roadways.

As an example, peak-hour congested roadways can be defined by government transportation plans. Peak-hours can be defined, for example, as from 5:30-9:00 am and 3:00-7:00 pm. According to one embodiment, for a DART to be considered a peak-hour congested DART, the ridesharing trip must be undertaken as follows: (1) 25% of the trip must be along one of the congested roadways specified; and (2) 50% of the trip must be between peak-hours (5:30-9:00 am and 3:00-7:00 pm). Trips that do not meet these criteria are classified as regular DARTs, which do not include the congestion relief contribution and are therefore priced at 3.3¢/VMT.

Based on the above DART calculations, for the exemplary Northern Virginia implementation, the rideshare credit organization could purchase up to about $2 M worth of DARTs, which equates to reductions of approximately 24 million VMT, 33 tons NOx, and 12 tons VOC. Virginia, as the rideshare credit organization, would purchase congestion relief in the form of DARTs as a deliverable quantity. In contrast to traditional programs, where funds are expended in anticipation of congestion relief, the present invention provides a pay-for-performance model, whereby funds are expended to purchase DARTs only after they have been produced and verified. By specifying a cap of $2 M, the rideshare credit organization would be purchasing the maximum amount of congestion relief possible, at a pre-determined price, and with no risk since only delivered quantities of congestion relief (DARTs) are purchased. With this method, the service provider assumes all of the risk of delivering the DARTs, and should the service provider be unable to deliver the DARTs, then no payments would be made.

### Exemplary User Interface

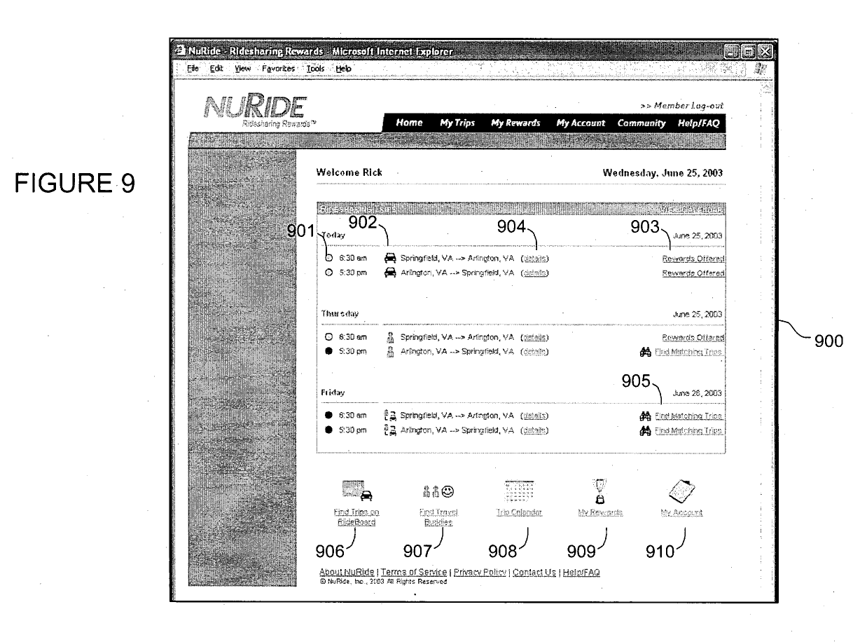

As an example of a specific implementation of the present invention, FIGS. 9-16 show a series of screen images through which a rideshare participant can register with and participant in a rideshare program. FIG. 9 shows a main screen 900 of an exemplary user interface for facilitating a rideshare program, according to an embodiment of the present invention. As shown, main screen 900 lists the planned rideshare trips of a rideshare participant along with the status for each trip 901, the role (drive or ride) for the participant 902, the rideshare incentive 903, a link to the full trip details 904, and, for trips that are incomplete, a link to find matching trips 905. Also included on the main screen 900 are links to find trips 906, find travel buddies 907, view a trip calendar 908, view ridesharing incentives 909, and to setup a participant's account 910. Calendar function 908 displays trip originations, destinations, departure times, holidays, etc. on a calendar. Rideshare search function 906 enables a participant to search for other compatible rideshare trips and search function 907 enables a participant to search for travel buddies with whom the participant could potentially rideshare.

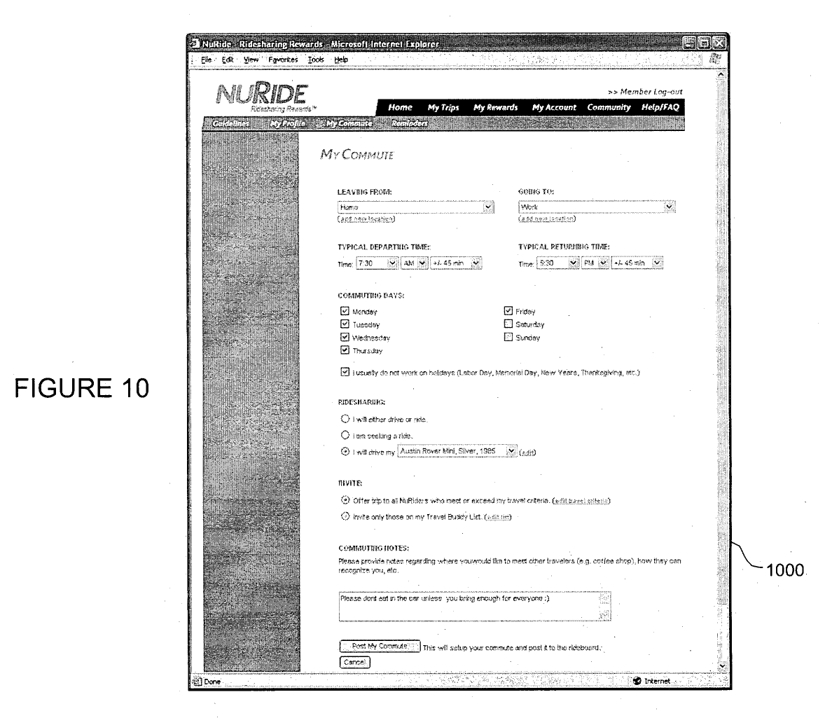

Before executing these functions, however, a rideshare participant preferably provides profile information to the service provider, which includes, for example, personal information (name, address, telephone number, email address, etc.), typical commute information, driver information, and travel preferences. FIG. 10 illustrates an exemplary user interface 1000 through which a rideshare participant enters commute information such as origination, destination, departure time, return time, commuting days, riding/driving preference, scope of invitations to rideshare, and any special notes.

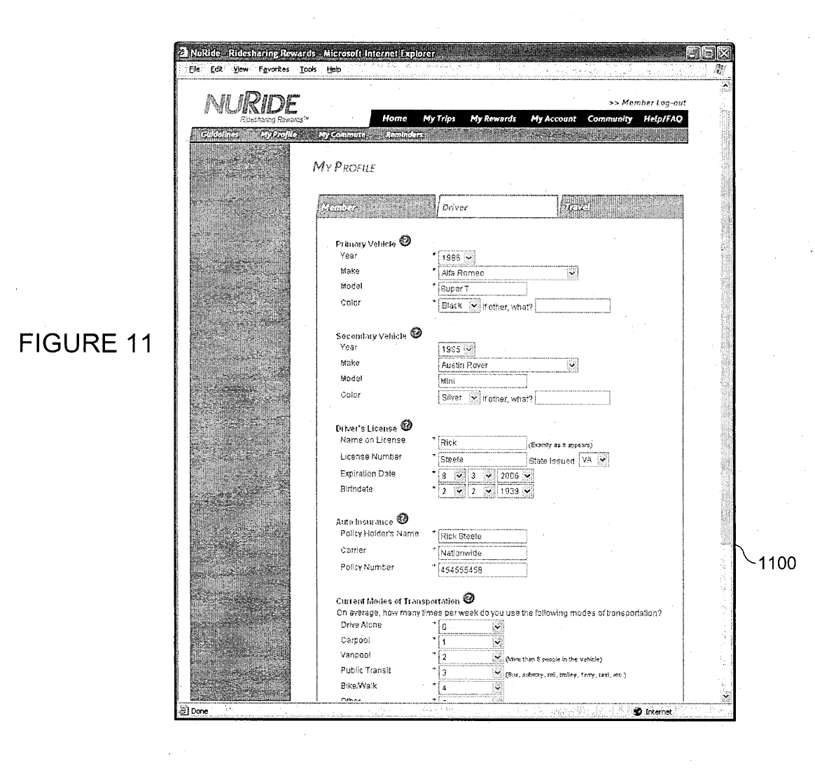

FIG. 11 illustrates an exemplary user interface 1100 through which a rideshare participant enters driver information such as type of vehicle, driver's license information, auto insurance information, and current modes and frequencies of transportation (which can be used by the service provider to calculate the emissions and congestion relief attributable to a particular rideshare participant).

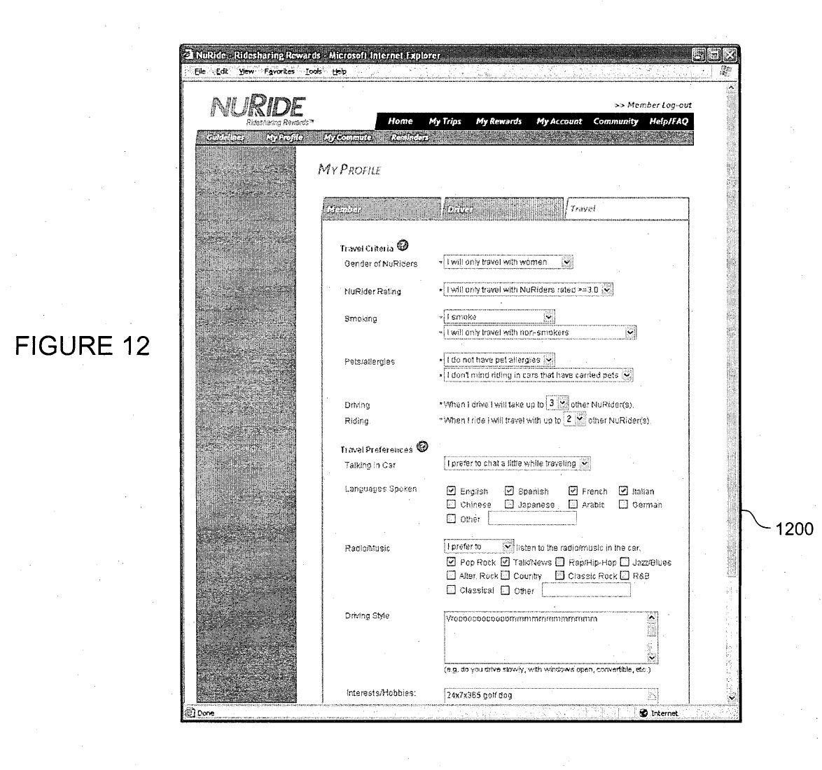

FIG. 12 illustrates an exemplary user interface 1200 through which a rideshare participant enters travel criteria and travel preferences. In this example, the travel criteria include the gender of rideshare participants that a rideshare participant is willing to travel with, the rating of rideshare participants that a participant is will to travel with, whether the participant will travel with smokers, whether the participant has carried pets in his vehicle or is willing to travel with drivers who have, and the number of participants the participant is willing to ride with or drive. The travel preferences address talking, languages spoken, radio use, and driving style.

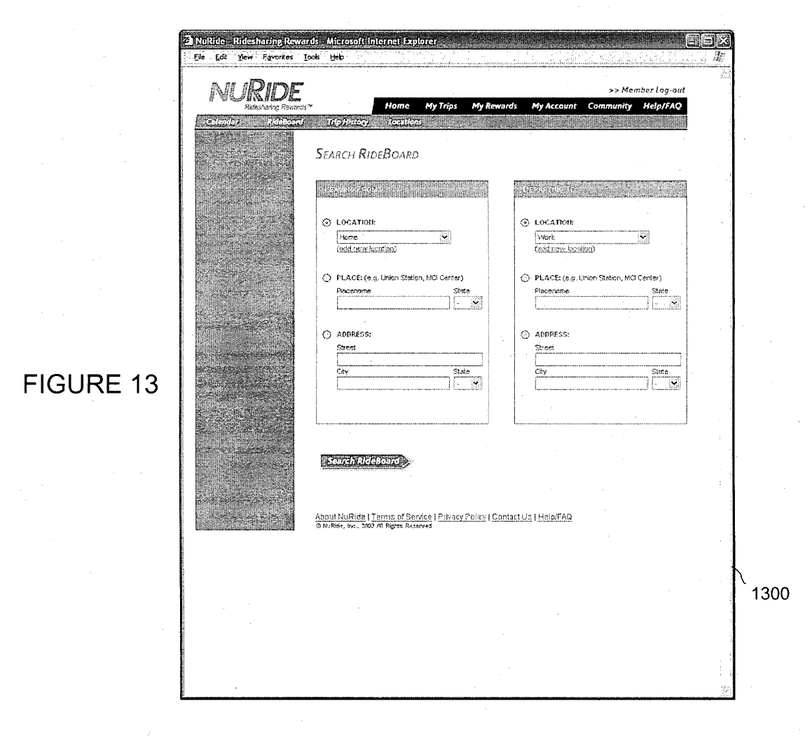

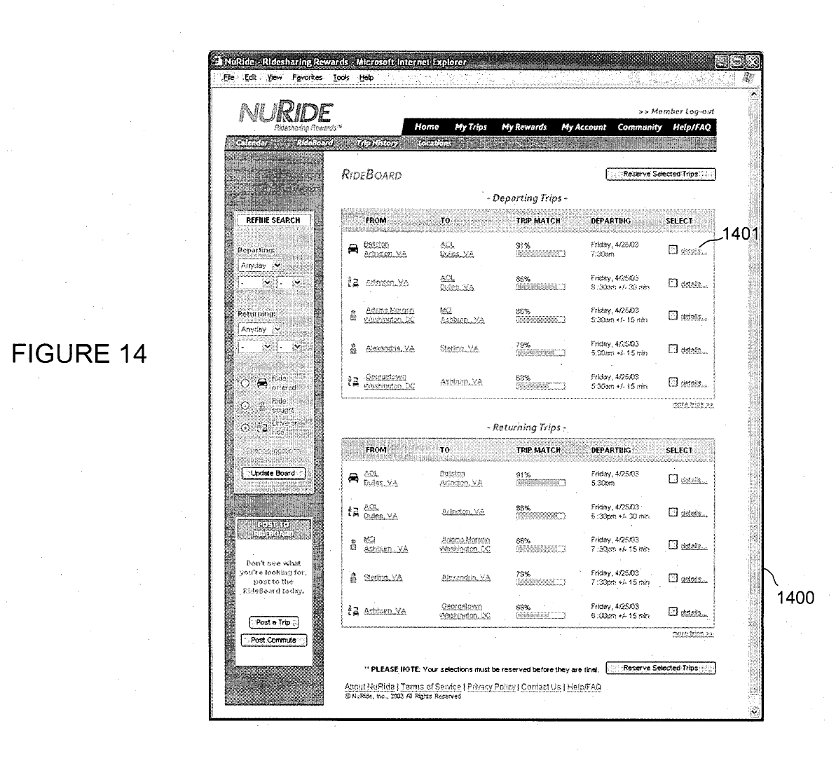

With profile information entered, this exemplary implementation of the present invention provides a user interface for searching for compatible rideshare trips, as shown FIGS. 13 and 14. A rideshare participant accesses this function by, for example, clicking through rideshare search function 906 of FIG. 9. In the search screen 1300 of FIG. 13, a rideshare participant enters origination and destination information.

In response, the user interface displays a search report screen 1400 as shown in FIG. 14, which presents a rideboard listing of matching rideshare trips. As shown, the rideboard lists information on the other participants' trips, including origination, destination, percentage of match to inquiring participant's trips, and departing times. The rideboard also allows the inquiring rideshare participant to select a potential trip, receive more information on the trip and its associated rideshare participant, and eventually contact the other rideshare participant to arrange a rideshare.

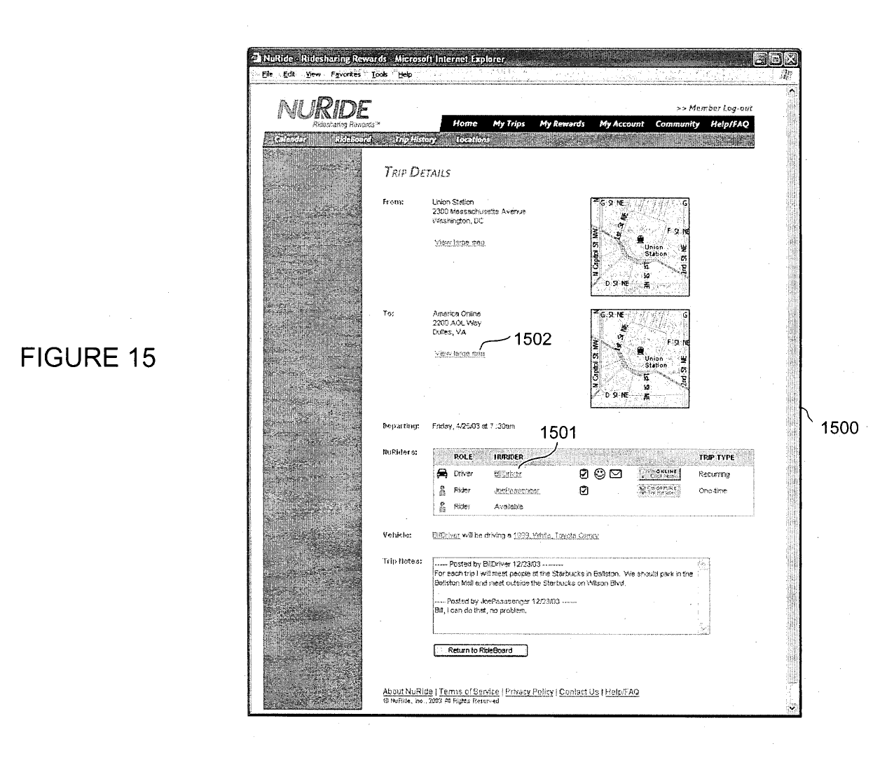

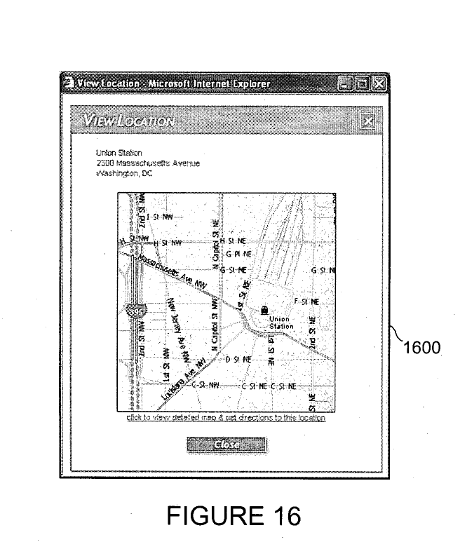

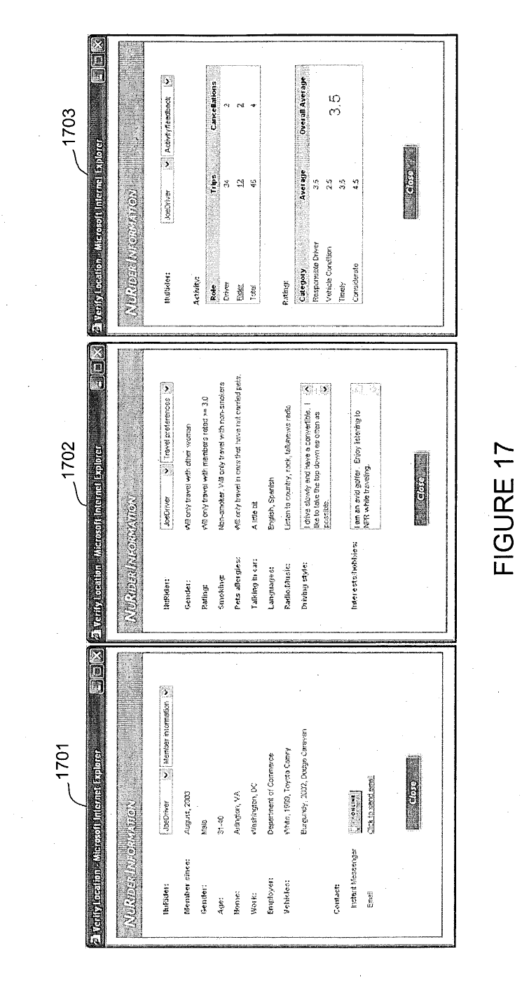

FIG. 15 illustrates the type of details that are presented for a trip that is selected from the rideboard link 1401 in FIG. 14. By selecting link 1502 from the trip details page 1500 of FIG. 15, the user can see detailed information about the trip origination and destination locations, as shown in the view location screen 1600 of FIG. 16. Furthermore, in response to the selection of link 1501 from the trip details page 1500 of FIG. 15, the user is presented with detailed information for each potential ridesharing partner as shown in screens 1701, 1702, and 1703 of FIG. 17.

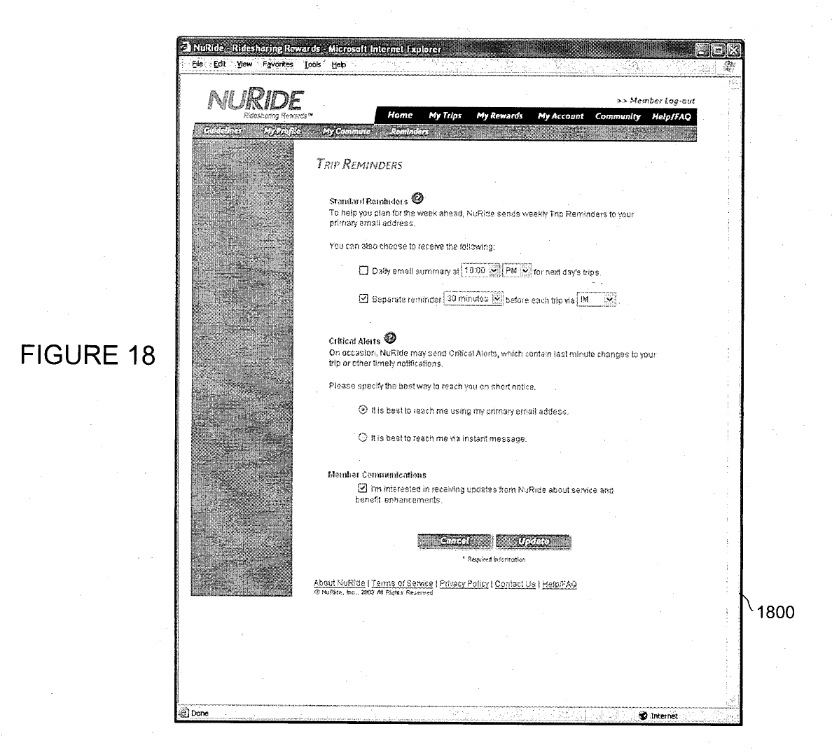

After a trip has been planned, a further aspect of the present invention provides the rideshare participants with reminders of the upcoming trip. FIG. 18 illustrates an exemplary user interface 1800 for establishing these trip reminders, according to an embodiment of the present invention. As shown, a rideshare participant can specify how often and to what email address to send trip reminders as well as last minute trip changes.

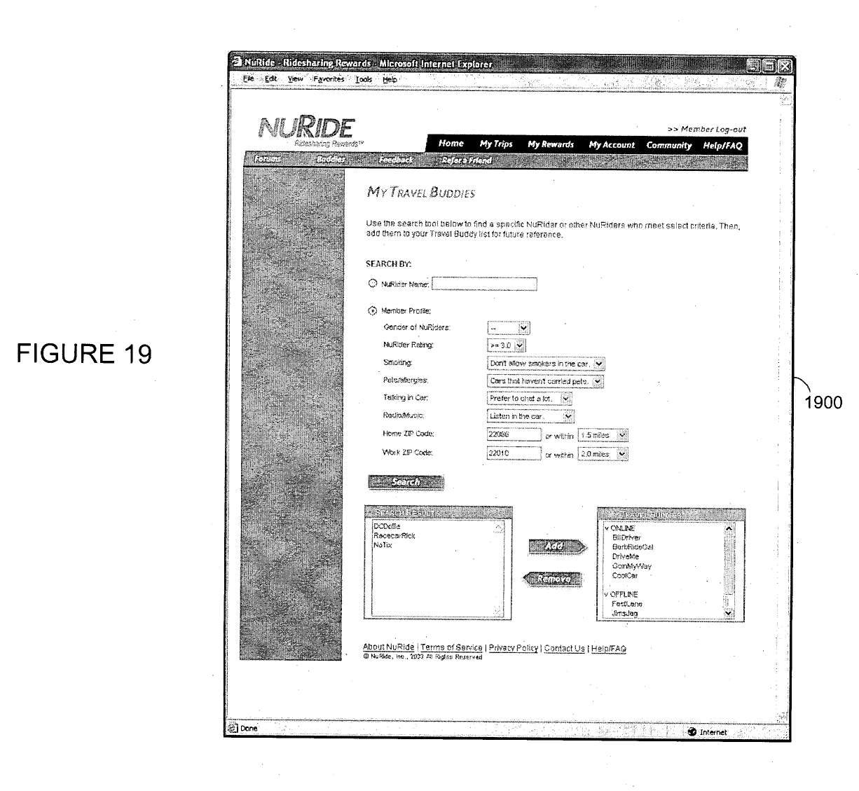

A user can also search for travel buddies by selecting link 907 from the main screen 900 of FIG. 9. FIG. 19 illustrates an exemplary user interface 1900 for searching for and managing a list of travel buddies.

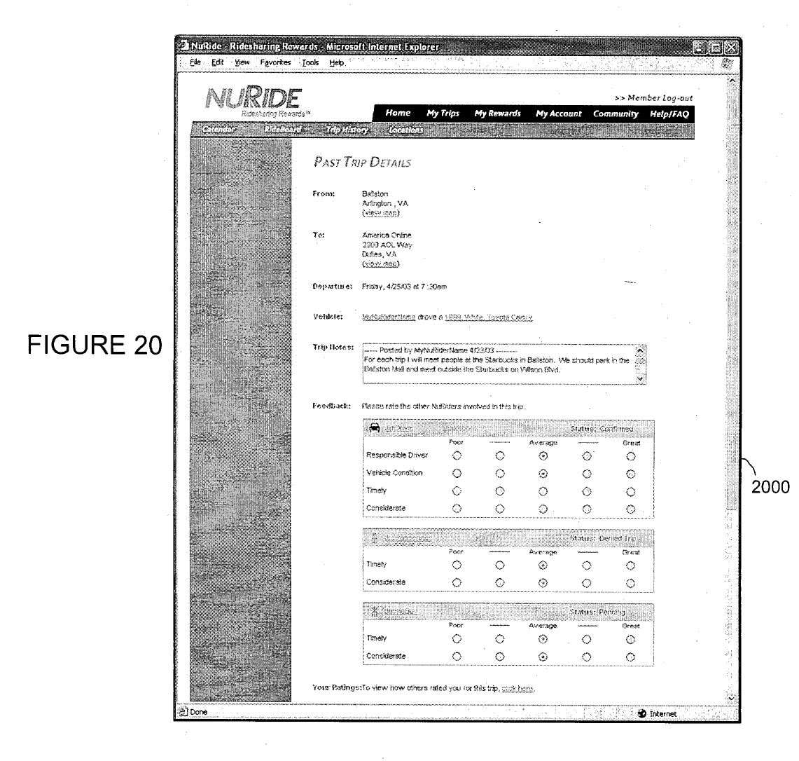

After completing trips, a further aspect of the present invention provides a rideshare participant with a record of completed trips. FIG. 20 illustrates an exemplary user interface 2000 for reporting this rideshare trip activity and for rating fellow ridesharing participants.

In accordance with an embodiment of the present invention, instructions adapted to be executed by a processor to perform a method are stored on a computer-readable medium. The computer-readable medium can be a device that stores digital information. For example, a computer-readable medium includes a read-only memory (e.g., a Compact Disc-ROM (“CD-ROM”) as is known in the art for storing software. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

As used to describe embodiments of the present invention, the term “coupled” encompasses a direct connection, an indirect connection, or a combination thereof. Two devices that are coupled can engage in direct communications, in indirect communications, or a combination thereof. Moreover, two devices that are coupled need not be in continuous communication, but can be in communication typically, periodically, intermittently, sporadically, occasionally, and so on. Further, the term “communication” is not limited to direct communication, but also includes indirect communication.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for facilitating ridesharing comprising:
tracking a quantity of rideshare participation by a rideshare participant;
awarding an incentive to the rideshare participant based on the quantity; and
receiving payments based on the rideshare participant's quantity of rideshare participation.

2. The method of claim 1, wherein the quantity of rideshare participation is one of a number of rideshare miles traveled, a number rideshare trips taken, an amount of reduced emissions, a number of passengers taken, a time of day traveled, and a type of roadway taken.

3. The method of claim 1, wherein the payments are received from a government agency.

4. The method of claim 3, wherein the payments are based on reduced vehicle miles traveled.

5. The method of claim 3, wherein the payments are based on a sum of a value of reduced emissions, a value of reduced roadway maintenance, and a value of peak-hour congestion relief.

6. The method of claim 1, wherein receiving payments comprises receiving credits based on the rideshare participant's quantity of rideshare participation and selling the credits.

7. The method of claim 6, wherein the credits are based on at least one of reduced emissions, reduced vehicle miles traveled, reduced roadway maintenance, and reduced traffic congestion.

8. The method of claim 7, wherein the reduced emissions comprise at least one of reduced NOx, reduced VOC, and reduced CO₂.

9. The method of claim 1, wherein the incentive comprises at least one of a monetary reward, store credits, entry into a lottery for a prize, gift rewards, and customer status benefits.

10. The method of claim 1, further comprising confirming the quantity of rideshare participation by the rideshare participant.

11. The method of claim 10, wherein confirming comprises, for each trip of the rideshare participant, contacting associated rideshare participants that accompanied the rideshare participant on the trip and receiving from the associated rideshare participants confirmation that the trip was actually taken.

12. The method of claim 10, wherein confirming comprises monitoring the rideshare participant with a global positioning system.

13. The method of claim 1, wherein the quantity is rideshare miles, wherein tracking the quantity comprises allotting a first amount of rideshare miles for each mile traveled as a driver and allotting a second amount of rideshare miles for each mile traveled as a passenger, and wherein the first amount is different from the second amount.

14. The method of claim 1, further comprising receiving from the rideshare participant an assignment of the rideshare participant's ownership of credits derived from the ridesharing.

15. The method of claim 1, further comprising receiving a membership fee from the rideshare participant.

16. The method of claim 1, further comprising:
receiving information on a desired rideshare trip from the rideshare participant;
identifying potential rideshare participants having rideshare trips compatible with the desired rideshare trip; and
displaying the potential rideshare participants to the rideshare participant.

17. A method for facilitating ridesharing comprising:
tracking a number of rideshare miles traveled by a rideshare participant;
awarding an incentive to the rideshare participant based on the number of rideshare miles traveled;
receiving credits based on the number of rideshare miles traveled; and
selling the credits.

18. The method of claim 17, further comprising:
informing the rideshare participant of the incentive and the number of rideshare miles traveled through a user interface;
displaying advertising, sponsorships, and surveys on the user interface; and
collecting fees for the advertising, sponsorships, and surveys.

19. The method of claim 17, wherein the incentive is provided by a vendor partner, and wherein the method further comprises collecting a transaction fee from the vendor partner.

20. The method of claim 17, wherein the credits are sold on an emissions trading market.

21. The method of claim 17, wherein selling the credits comprises receiving payment for the credits from a government agency.

22. The method of claim 17, further comprising receiving from the rideshare participant an assignment of the rideshare participant's ownership of the credits derived from the ridesharing.

23. A system for facilitating ridesharing comprising:
an application adapted to track a quantity of participation in the ridesharing by a rideshare participant, calculate an incentive for the rideshare participant based on the quantity, and display the incentive to the rideshare participant; and
a participation tracking database in communication with the application, wherein the quantity is recorded in the participation tracking database.

24. The system of claim 23, wherein the quantity is one of a number of rideshare miles traveled, a number rideshare trips taken, an amount of reduced emissions, a number of passengers taken, a time of day traveled, and a type of roadway taken.

25. The system of claim 23, wherein the quantity comprises credits, and wherein the participation tracking database is accessible to a rideshare credit organization.

26. The system of claim 25, wherein the rideshare credit organization makes the credits available for sale.

27. The system of claim 23, wherein the application is further adapted to calculate a compensation to be received based on the quantity.

28. The system of claim 23, wherein the application is further adapted to:
receive information on a desired rideshare trip from the rideshare participant;
identify potential rideshare participants having rideshare trips compatible with the desired rideshare trip; and
display the potential rideshare participants to the rideshare participant.

29. The system of claim 28, wherein the application is further adapted to ensure that potential rideshare participants and the rideshare participant have compatible travel preferences.

30. A computer-readable medium storing a plurality of instructions adapted to be executed by a processor for facilitating ridesharing, the plurality of instructions comprising instructions to:
track a quantity of rideshare participation by a rideshare participant;
award an incentive to the rideshare participant based on the quantity; and
receive payments based on the rideshare participant's quantity of rideshare participation.
